(19) United States
(12) Patent Application Publication
(10) Pub. No.: US 2025/0065863 A1
(43) Pub. Date: Feb. 27, 2025

(54) CONTROL SYSTEM FOR HYBRID ELECTRIC VEHICLE

(71) Applicant: Cummins Inc., Columbus, IN (US)

(72) Inventors: Dat D. Le, Columbus, IN (US); Kenneth Follen, Columbus, IN (US); Jaroslaw Leonarski, Columbus, IN (US); Carlos Lana, Columbus, IN (US); David Langenderfer, Columbus, IN (US)

(73) Assignee: Cummins Inc., Columbus, IN (US)

(21) Appl. No.: 18/722,749

(22) PCT Filed: Oct. 14, 2022
(86) PCT No.: PCT/IB2022/059857

§ 371 Date: Jun. 21, 2024

Related U.S. Application Data
(60) Provisional application No. 63/293,293, filed on Dec. 23, 2021.

(51) Int. Cl. B60W 20/13; B60W 10/06; B60W 10/08; B60W 10/26

(52) U.S. Cl. CPC B60W 20/13; B60W 10/06; B60W 10/08; B60W 10/26; B60W 2710/081; B60W 2710/083; B60W 2710/086

(57) ABSTRACT

Powertrains of hybrid electric vehicles, control systems for controlling the powertrains, and methods for controlling the powertrains are disclosed. The powertrain includes an engine, a motor/generator, a battery and a DC bus. The control system is configured to: operate the motor/generator in a first mode when the battery is connected to the DC bus; operate the motor/generator in a second mode when the battery is disconnected from the DC bus, wherein the second mode is a voltage control mode in which the motor/generator controls a voltage of the DC bus; and adjust at least one parameter of the powertrain to assist the motor/generator in controlling the voltage of the DC bus in the second mode.

### GOVERNMENT SUPPORT

This invention was made with Government support under DE-AC02-06CH11357 awarded by DOE. The Government has certain rights in this invention.

### FIELD OF THE DISCLOSURE

The present disclosure relates to a control system for a hybrid electric vehicle, and in particular (but not exclusively) a control system which can facilitate continued operation of the vehicle in the case of battery failure.

### BACKGROUND

Hybrid electric vehicles, such as cars, buses, vans and trucks, combine an internal combustion engine with an electric system to achieve better fuel economy, lower emissions and/or better performance. In the case of a series hybrid electric vehicle, the wheels are driven by a traction motor which is powered either by a battery, a generator set, or both. The generator set comprises an internal combustion engine and a motor/generator and is used to charge the battery and/or supply power to the traction motor and other vehicle accessories. In the case of a parallel hybrid electric vehicle, the wheels are mechanically driven by an internal combustion engine and/or an electric motor/generator. In the case of a series-parallel hybrid electric vehicle, the vehicle can operate in either in series hybrid mode, in which the engine mechanically disconnects from the wheels, or parallel hybrid mode, in which the engine mechanically connects to the wheels. The battery is typically in the form of a battery pack comprising a large number of individual electrochemical cells connected in series and parallel to achieve the target voltage. Typically, Lithium ion (Li-ion) battery cells are used as they provide a relatively good cycle life and energy density. During normal operation, the battery is connected to a DC bus, and the voltage of the DC bus is maintained by the battery. In this case, one of the engine and the motor/generator may be operated in a speed control mode or torque control mode and the other may be operated in a torque or power control mode. Series hybrid electric vehicles may also be referred to as extended-range electric vehicles (EREVs) or range-extended electric vehicles (REEVs).

During the lifetime of a battery, there is a chance of battery failure due for example to a fault in one or more battery cells. In the case of battery failure, the battery is disconnected from the DC bus in the interests of safety. The motor/generator may then supply electrical power to DC bus so that the vehicle can remain operational. In this case, the motor/generator may operate in a voltage regulation mode to maintain the DC bus voltage.

In this disclosure, a motor/generator may be an electric motor mechanically coupled to an internal combustion engine and operating in voltage regulation mode during battery failure. The motor/generator can function as the traction motor, mechanically coupled to the wheels, during normal operation, in an architecture such as a parallel hybrid architecture. The motor/generator can be mechanically isolated from the drivetrain (not function as the traction motor), during either normal operation or battery failure, in an architecture such as a series hybrid architecture. Mechanical coupling between the engine and the motor/generator can be, but is not limited to, coupling via a clutch, a transmission, a gear set, or direct coupling.

When the motor/generator is operating in a voltage regulation mode, it needs to respond to changes in load on the DC bus. However, the limited torque response of a typical engine may lead to delays and lag in response to the changes. This may limit the ability of the motor/generator to maintain the DC bus voltage when operating in voltage regulation mode, especially if engine is in speed control mode (which is usually the case for series hybrid architectures). In particular, it may be difficult to maintain the DC bus voltage during transient events such as when the battery is being disconnected or during vehicle acceleration or deceleration. In some cases, these limitations may be exacerbated by one or more dead bands and low torque resolution zones in the engine torque map.

It would therefore be desirable to provide a control system for a hybrid electric vehicle in which the ability to regulate the DC bus voltage when the battery is disconnected can be improved.

### SUMMARY

According to one aspect of the present disclosure there is provided a control system for controlling a powertrain of a hybrid electric vehicle, the powertrain comprising an engine, a motor/generator, a battery and a DC bus, wherein the control system is configured to:
operate the motor/generator in a first mode when the battery is connected to the DC bus;
operate the motor/generator in a second mode when the battery is disconnected from the DC bus, wherein the second mode is a voltage control mode in which the motor/generator controls a voltage of the DC bus; and
adjust at least one parameter of the powertrain to assist the motor/generator in controlling the voltage of the DC bus in the second mode.

The present disclosure may provide the advantage that, by adjusting at least one parameter of the powertrain to assist the motor/generator in controlling the voltage of the DC bus, it may be possible to improve the ability of the system to control a DC bus voltage, particularly during transient events such as when the battery is being disconnected or during vehicle acceleration or deceleration. The ability to control the engine speed if the engine is in speed control mode or the engine torque delivery if the engine is in torque control mode may also be improved. This may help to ensure that the vehicle remains operational. Furthermore, vehicle safety may be improved by helping to ensure that the DC bus voltage is regulated for the operation of power steering and critical accessories.

In some examples, the control system is configured to operate the motor/generator in the first mode when a battery is connected to the DC bus and in the second mode when the battery is disconnected or about to be disconnected from the DC bus. For example, the control system may be arranged to determine whether the battery is disconnected or about to be disconnected, and to switch from the first mode to the second mode when it is determined that the battery is disconnected or about to be disconnected. The first mode may be a mode in which a parameter of the motor/generator other than voltage, such as speed, torque or power, is controlled. Thus, the first mode may be one of a torque control mode, a power control mode and a speed control mode. The second mode may be the voltage control mode, in which the voltage of the motor/generator is controlled.

In some examples, in the second mode, the control system adjusts the at least one parameter of the powertrain to assist in controlling a parameter of the engine. The parameter of the engine may be engine speed if the engine is in a speed control mode or engine torque delivery if the engine is in a torque control mode.

In some examples, the control system is arranged to adjust the at least one parameter according to predetermined relationships between DC bus voltage, speed or torque of the engine, and the parameter. In particular, the control system may be arranged to adjust the at least one parameter according to a predetermined relationship between DC bus voltage, speed of the engine, the parameter, and the torque of the engine. This can allow the control system to take into account known limitations in the engine torque response and to adjust the at least one other parameter accordingly, to help maintain the DC bus voltage while controlling the speed of the engine if the engine is in speed control mode or controlling the torque the engine delivers if the engine is in torque control mode. The predetermined relationship may be for example in the form of a formula or table, or in any other form, and may be stored in memory.

The control system may be arranged to (temporarily) adjust the at least one parameter in response to a change in load on the DC bus. This may allow the generator set time to respond to a change in load on the DC bus. For example, the engine may have an engine torque map, and temporarily adjusting the at least one parameter may allow time for the engine to change from operating in one part of the engine torque map to another part of the engine torque map in response to the change in load. The engine torque map may be a map of engine torque against speed, and may be for example in the form or a table, chart or formula, or in any other appropriate form, and may be stored in memory.

In some examples, the parameter is at least one of a power consumption of a power consuming component and a power reserve of the engine. For example, a power reserve of the engine may be adjusted via torque reserve and/or increased engine speed. In the case of a power consuming component, the component may be at least one of an electrical accessory, a brake resistor, and a traction motor (for architectures having a traction motor). This may allow an existing component to be used to help regulate the voltage of the DC bus when the motor/generator is operating in voltage control mode. It will be understood that in some cases a power consuming component such as the traction motor (for architectures having a traction motor) may also be able to supply power, for example, via regenerative braking.

For example, the control system may be configured to use at least one of: engine torque reserve; motor/generator torque; variation of traction motor torque from drive demand torque; variation of accessories power from accessories power demand; and brake resistor power as a control variable to control the voltage of the DC bus (and in some examples, the speed if the engine is in a speed control mode or engine torque delivery if the engine is in a torque control mode). This may be done according to a predetermined relationship between the relevant parameter and the voltage of the DC bus and/or between the relevant parameter and the speed of the engine. It may be possible to at least partially adjust the values of these parameters without adversely affecting overall operation of the vehicle, and thus this may facilitate control of the DC bus voltage.

When the motor/generator is operating in voltage control mode, the control system is, in some examples, configured to control a voltage at the output of the motor/generator. Thus, the control system may be configured to control a voltage at the output of the motor/generator and a speed of the engine if the engine is in speed control mode or engine torque delivery if the engine is in torque control mode. This may help to ensure that the engine operates at a preferred speed, including not stall, as well as helping to maintain the voltage of the DC bus.

The control system may be configured to control the motor/generator to charge the battery and/or to provide power for components on DC bus when the battery is connected to the DC bus. The control system may be configured to receive a signal indicating that the battery is about to be disconnected from the DC bus, and/or that the battery is disconnected from the DC bus, and to operate the motor/generator in the voltage control mode when the battery is disconnected from the DC bus. This may allow the powertrain to remain operational when the battery is disconnected.

In a preferred embodiment, the control system is configured to:
receive a signal indicating a predicted change in state of the DC bus; and
adjust the at least one parameter of the powertrain to assist the motor/generator in responding to the predicted change in state of the DC bus (in some examples, while controlling the engine speed if the engine is in speed control mode or engine torque delivery if the engine is in torque control mode).

In some examples, the control system is arranged to temporarily adjust the at least one parameter when it receives the signal indicating a predicted change in state. In this case, the control system may be configured to at least partially undo the adjustment when the state of the DC bus, which may include the state of the battery contactors, changes. This may allow the generator set time to respond to the predicted change in state of the DC bus. In particular, it may allow time for the engine to change its operation to a different part of its engine torque map before the change in state occurs. This may help to ensure that the engine is able to operate in the new state when it occurs, which may help to ensure that the voltage of the DC bus remains stable while controlling the speed of the engine if the engine is in speed control mode or engine torque delivery if the engine is in torque control mode.

The signal indicating a predicted change in state may be a signal indicating that a battery will be disconnected from the DC bus. In this case, the adjustment of the parameter may comprise at least one of turning on or increasing a power consumption of a power consuming component and applying or increasing a power reserve of the engine. The power consuming component may be for example an electrical accessory, a brake resistor or the traction motor (for architectures having a traction motor). In this context, the term “increasing a power consumption” should be understood as including the case that, where the component is supplying power, the amount of power supplied is reduced. The adjustment may be at least partially undone when the battery is disconnected. This may allow the generator set time to prepare for the disconnection of the battery before the battery is disconnected, and thus may help to maintain the DC bus voltage while controlling the speed of the engine if the engine is in speed control mode or engine torque delivery if the engine is in torque control mode when the battery is disconnected.

Alternatively, or in addition, the signal indicating a predicted change in state may be a signal indicating a predicted change in electrical load on the DC bus. In this case, the control system may be configured such that, when the signal indicating a predicted change in state indicates that the load on the DC bus will increase, the control system performs at least one of: turning on or increasing a power consumption of a power consuming component; and applying or increasing a power reserve of the engine. The control system may be configured to at least partially undo the adjustment when the load increases. The control system may also be configured such that, when the signal indicating a predicted change in state indicates that the load on the DC bus will decrease, the control system performs at least one of: turning off or decreasing a power consumption of a power consuming component; and removing or decreasing a power reserve of the engine. The control system may be configured to at least partially undo the adjustment when the load decreases. This may allow the generator set time to prepare for the change in load before the change in load occurs, and thus may help to maintain the DC bus voltage and control the speed of the engine if the engine is in speed control mode or engine torque delivery if the engine is in torque control mode when the change in load occurs.

The control system may comprise a look-ahead predictor arranged to determine a predicted change in electrical load and to output the signal indicating a predicted change in electrical load. The electrical load includes but is not limited to driver demand power and accessories' powers. The look-ahead predictor may use any appropriate data, such as satellite positioning data, mapping data, weather data, traffic data, vehicle data, fleet data, historic data, or any combination thereof, to predict a change in electrical load. The data may be stored locally and/or on cloud to be communicated to the vehicle.

The engine may be an internal combustion engine such as a diesel engine or a spark ignited engine, or any other appropriate type of engine. In some cases, the engine may have one or more dead zones in its torque map where it is not able to operate stably. In some cases, the engine may have one or more low torque resolution zones in its torque map where its torque control resolution is limited. Thus, the control system may be configured to adjust the at least one parameter of the powertrain to avoid operating the engine in a dead zone and/or to assist operating the engine in a low torque resolution zone of the engine's torque map. This may help to control the DC bus voltage more finely while controlling the speed of the engine if the engine is in speed control mode or engine torque delivery if the engine is in torque control mode.

The control system may further comprise at least one of: an engine control module for controlling the engine; an inverter controller for controlling an inverter between the motor/generator and the DC bus; an inverter controller for controlling an inverter between the DC bus and the traction motor (for architectures having a traction motor); an accessories controller for controlling a power of one or more electrical accessories; and a brake resistor controller for controlling a brake resistor.

According to another aspect of the disclosure there is provided a powertrain for a hybrid electric vehicle, the powertrain comprising:
an engine;
a motor/generator;
a DC bus;
a battery configured to supply power to the DC bus; and
a control system, wherein the control system is configured to:
   operate the motor/generator in a first mode when the battery is connected to the DC bus;
   operate the motor/generator in a second mode when the battery is disconnected from the DC bus, wherein the second mode is a voltage control mode in which the motor/generator controls a voltage of the DC bus; and
   adjust at least one parameter of the powertrain system to assist the motor/generator in controlling the voltage of the DC bus in the second mode.

The powertrain may be a series hybrid powertrain, a parallel hybrid powertrain, or a series-parallel hybrid powertrain. In the case of a series hybrid powertrain or a series-parallel hybrid powertrain, the powertrain may comprise a traction motor. In the case of a parallel hybrid powertrain or a series-parallel hybrid powertrain the motor/generator may be able to supply mechanical power to the vehicle's wheels.

In some examples, the battery is removably connected to the DC bus. The battery may comprise a battery management system, and the battery management system may be configured to output a signal indicating that the battery needs to be disconnected (for example, a signal indicating that the battery will be disconnected, or a signal indicated that the battery should be disconnected by another part of the system such as a system control module). In this case, the control system may be configured to switch the motor/generator from the first mode to the second mode when a signal indicating that the battery will be disconnected is received from the battery management system. In the first mode, the control system may operate the motor/generator in one of a speed control mode, a torque control mode and a power control mode. In the second mode, the control system may operate the motor/generator in a voltage control mode and the engine in a speed control mode or torque control mode and may adjust the at least one parameter in any of the ways discussed above. The control system may also be arranged to at least partially undo the adjustment when the battery is disconnected.

The powertrain system may further comprise at least one of: contactors for connecting the battery to the DC bus; an inverter between the motor/generator and the DC bus; an inverter between the DC bus and the traction motor (for architectures having a traction motor); one or more electrical accessories; and a brake resistor.

Corresponding methods may also be provided. Thus, according to another aspect of the disclosure there is provided a method of controlling a powertrain of a hybrid electric vehicle, the powertrain comprising an engine, a motor/generator, a DC bus and a battery for supplying power to the DC bus, the method comprising:
operating the motor/generator in a first mode when the battery is connected to the DC bus;
operating the motor/generator in a second mode when the battery is disconnected from the DC bus, wherein the second mode is a voltage control mode in which the motor/generator controls a voltage of the DC bus; and
adjusting at least one parameter of the powertrain to assist the motor/generator in controlling the voltage of the DC bus in the second mode.

Features of one aspect of the disclosure may be used with any other aspect. Any of the apparatus features may be provided as method features and vice versa.

### BRIEF DESCRIPTION OF THE DRAWINGS

Preferred features of the present disclosure will now be described, purely by way of example, with reference to the accompanying drawings.

FIG. 1 shows parts of an exemplary hybrid powertrain system for a series hybrid electric vehicle;

FIG. 2 shows parts of a control system for the hybrid powertrain system of FIG. 1;

FIG. 3 shows parts of a series hybrid powertrain system in an embodiment of the disclosure;

FIG. 4 shows parts of a parallel hybrid powertrain system in an embodiment of the disclosure;

FIG. 5 shows parts of a series-parallel hybrid powertrain system in an embodiment of the disclosure;

FIG. 6 shows parts of a general control system which is applicable to FIGS. 3, 4 and 5;

FIG. 7 is a block diagram of a hybrid control system, which is applicable in both normal mode and battery failure mode, in an embodiment of the disclosure;

FIG. 8 is a flow chart showing overall operation of a system control module in one embodiment;

FIG. 9 is a flow chart showing steps taken when the system is in a “prepare for battery disconnect” mode;

FIG. 10 is a flow chart showing steps taken when the battery is disconnected;

FIG. 11 is a flow chart showing steps taken when the system is in a voltage control mode;

FIG. 12 illustrates the principle of torque reserve using spark timing; and

FIG. 13 shows the engine map of a spark-ignited engine.

### DETAILED DESCRIPTION OF EMBODIMENTS OF THE DISCLOSURE

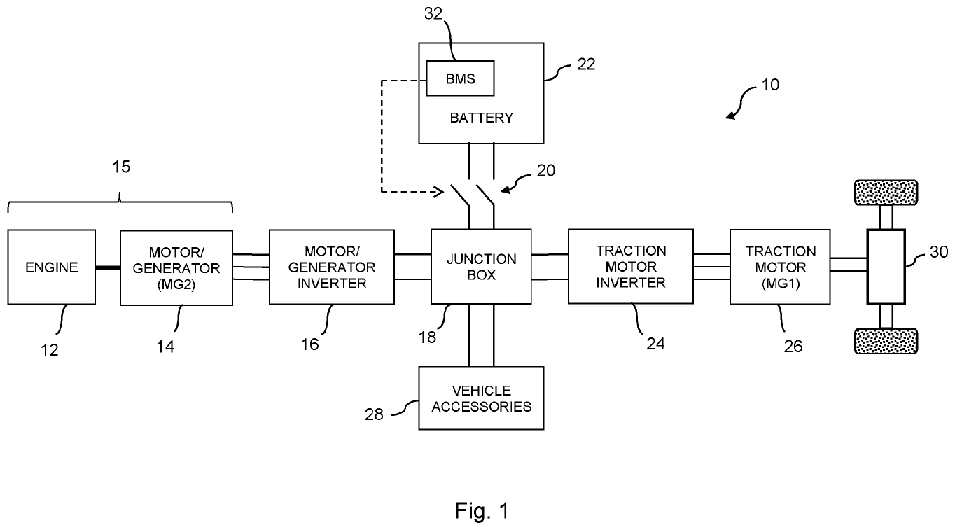

FIG. 1 shows parts of an exemplary hybrid powertrain system for a series hybrid electric vehicle. The powertrain system may, for example, be such as disclosed in International patent application publication number WO 2018/182608 or United States patent application publication number US 2020/0189564, the subject matter of both of which is incorporated herein by reference.

Referring to FIG. 1, the powertrain system 10 comprises engine 12, motor/generator (MG2) 14, motor/generator inverter 16, junction box 18, contactors 20, battery 22, traction motor inverter 24, traction motor (MG1) 26, electrical accessories 28 and vehicle drivetrain 30. The engine 12 is mechanically connected to the motor/generator 14 and is configured to drive the motor/generator 14 to generate electrical energy. The motor/generator 14 may also operate as a starter motor to start the engine 12, or alternatively a separate starter motor could be used. The motor/generator 14 is electrically connected to the inverter 16. The inverter 16 is configured to convert an AC output from the motor/generator 14 to DC for supply to the junction box 18. The inverter 16 may also be used to drive the motor/generator 14 when it is operating as a motor. The inverter 16 is electrically connected to the junction box 18. The junction box 18 is electrically connected to the battery 22 via battery contactors 20. The junction box 18 is also electrically connected to the traction motor inverter 24, and electrical accessories 28. The junction box 18 is configured to provide a DC bus between the inverter 16, the battery 22, the inverter 24, and the electrical accessories 28. The traction motor inverter 24 is configured to convert a DC voltage on the DC bus to AC to drive the traction motor (MG1) 26. The traction motor 26 is mechanically connected to the vehicle drivetrain 30. The traction motor 26 is used to drive the vehicle drivetrain 30 using electrical power from the battery 22 and/or the motor/generator 14. The traction motor 26 may also operate as a generator and may use regenerative braking to convert mechanical power from the drivetrain 30 to electrical power to provide power to the components on DC bus, such as the battery 22, the vehicle accessories 28, and the inverter 16. In this case, the traction motor inverter 24 may be used to convert an AC output of the traction motor 26 (when operating as a generator) to DC for supply to the battery 22 via the junction box 18 and the contactors 20. The vehicle drivetrain 30 typically comprises a drive shaft and a differential connected to driven wheels, in a manner known in the art. The electrical accessories 28 may comprise components such as a heater, DC/DC converter, power steering inverter, compressor, fan, etc.

In operation, the traction motor 26 is used to supply mechanical power to the vehicle drivetrain 30. Electrical power for the traction motor 26 is supplied from the inverter 16 and/or the battery 22 via the contactors 20, junction box 18 and the inverter 24. The traction motor 26 may also operate in regenerative braking mode in which the vehicle's momentum is used to recover electrical energy to provide energy to components on DC bus. The engine 12 and motor/generator 14 form a generator set 15 which is used to charge the battery 22 via the inverter 16, junction box 18 and contactors 20 and provide power to the traction motor 26 via the inverter 16, junction box 18, and inverter 24. The battery may also be charged from an external power source (plugin hybrid). The motor/generator 14 may be used to start the engine 12 using power from the battery 22 and/or inverter 24. Alternatively, a separate starter motor and/or a separate battery could be provided for this purpose. The battery 22 includes a battery management system 32 which is used to monitor and manage charge and discharge of the battery. The battery management system includes a processor with the appropriate software, along with memory and other components, which are used to monitor and manage charge and discharge.

In the series hybrid electric arrangement of FIG. 1, the engine 12 is mechanically isolated from the drivetrain 30. This allows the engine to be switched off when not required and to operate at an efficient operating condition when in use. Under normal operating conditions, the DC bus voltage at the junction box 18 is maintained by the battery 22. Either the engine 12 or the motor/generator 14 controls the speed of the generator set 15 (comprising engine 12 and motor/generator 14) while the other controls the torque.

In use, battery failure may occur, for example, due to faults in the battery cells, overheating, and/or overcurrent. In the case of battery failure, the battery management system 32 instructs the contactors 20 to disconnect the battery 22 from the junction box 18.

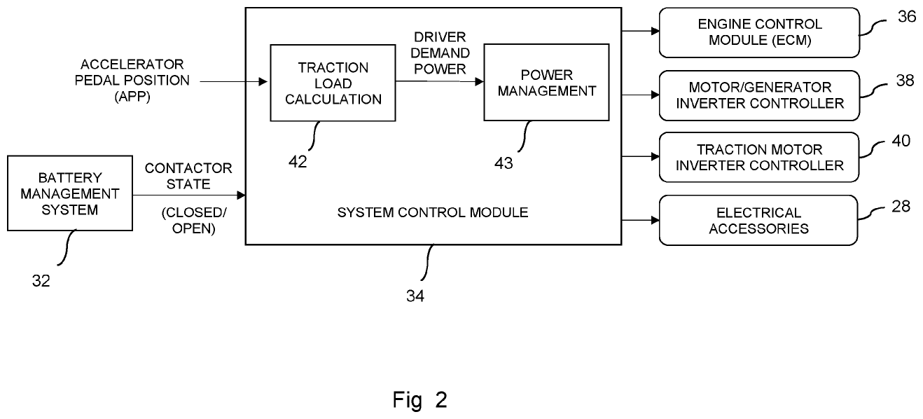

FIG. 2 shows parts of a control system for the hybrid powertrain system of FIG. 1. Referring to FIG. 2, the system comprises a system control module (SCM) 34 which is used to perform overall system control. The system control module 34 may be implemented as a processor executing the appropriate software, along with memory and other components. The system control module 34 includes a traction load calculation unit 42 and a power management unit 43. The system control module 34 receives an accelerator pedal position (APP) signal from the vehicle's accelerator pedal and other signals not shown in FIG. 2 which are fed to traction load calculation unit 42. The traction load calculation unit 42 and the power management unit 43 calculate control signals for the traction motor inverter controller 40 to meet the driver demand power within system capability. The system control module 34 also provides control signals for the engine control module (ECM) 36 and the motor/generator inverter controller 38 so as to control the torque of the engine 12 and the speed of the motor/generator 14, or vice versa. The power that the system control module 34 commands to the generator set controllers, including the engine control module 36 and the inverter controller 38, is determined by the power management unit 43. This essentially determines power split between generator set and battery to provide/absorb power to/from electrical loads. The engine control module 36 is configured to control the engine 12, for example, via an intake air throttle. In addition, the system control module provides control signals for the electrical accessories 28. Typically, these controllers are separate controllers and communicate to each other via CAN (Controller Area Network) or other types of communication.

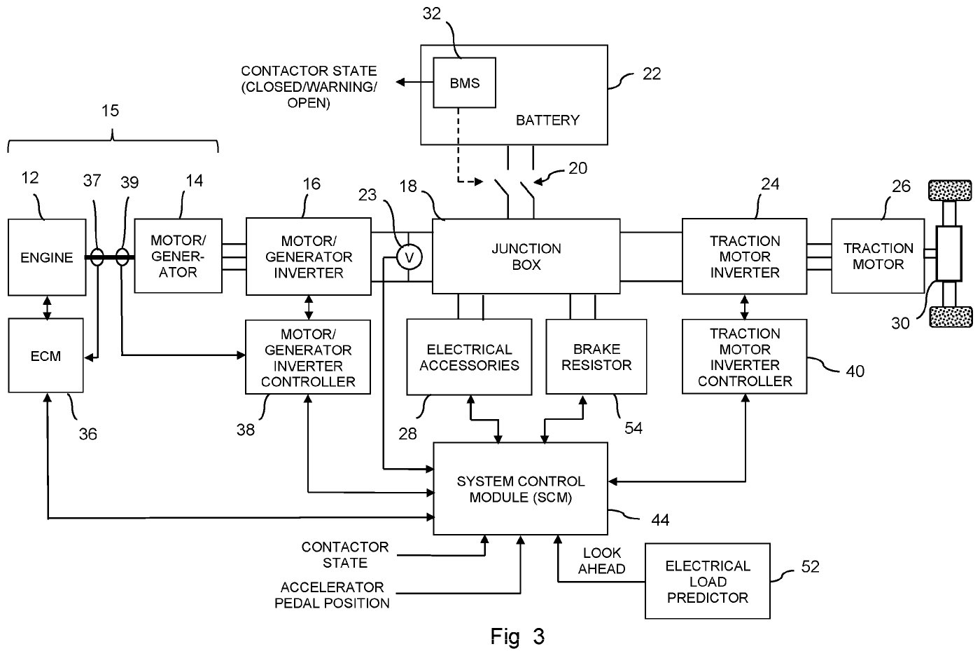

FIG. 3 shows parts of a hybrid powertrain system in an embodiment of the disclosure. In this embodiment, the powertrain system includes a battery management system that provides a signal to the system control module to inform the system control module that the battery contactors are closed, about to open, or opened. This signal is used by the system control module to prepare the generator set and other components for the moment that the contactors open and to control the system when the contactors are open. The powertrain system uses different actuation levers for the control: engine, motor/generator, traction motor, electrical accessories, and/or brake resistor.

Referring to FIG. 3, the system comprises engine 12, motor/generator 14, motor/generator inverter 16, junction box 18, contactors 20, battery 22, voltage sensor 23, traction motor inverter 24, traction motor 26, electrical accessories 28, vehicle drivetrain 30, engine control module (ECM) 36, engine speed sensor 37, motor/generator inverter controller 38, motor/generator speed sensor 39, traction motor inverter controller 40, system control module 44, electrical load predictor 52 and brake resistor 54. The engine 12, motor/generator 14, inverter 16, junction box 18, contactors 20, battery 22, inverter 24, traction motor 26 and electrical accessories 28 may be the same or similar to those described above. The engine 12 and motor/generator 14 form a generator set 15. The engine control module 36 is configured to control the engine 12, for example by controlling the engine's intake air throttle (IAT) and/or other engine parameters. The engine speed sensor 37 senses the speed of the engine for use in the control process. The inverter controller 38 is used to control the inverter 16, and thus the motor/generator 14. The motor/generator speed sensor 39 senses the speed of the motor/generator for use in the control process. The inverter controller 38 comprises sensors such as voltage and/or current sensors which provide sensed values of voltage and/or current for use in the control process. The inverter controller 40 is used to control the inverter 24, and thus the traction motor 26. The inverter controller 40 comprises sensors such as voltage and/or current sensors which provide sensed values of voltage and/or current for use in the control process. The voltage sensor 23 senses the DC bus voltage and provides the sensed voltage to the system control module 44. The voltage sensor 23 may be part of the motor/generator inverter 16 or part of the traction motor inverter 24. The electrical load predictor 52 is used to produce a prediction of future electrical loads. The brake resistor 54 is used to dissipate excess energy when needed, such as when the traction motor 26 is acting as a generator (for example, when the vehicle is decelerating or going downhill) and battery 22 and other components cannot take all of the regenerative energy/power. The brake resistor 54 is connected to the DC bus and can be controlled with a switching device such as a transistor.

In the arrangement of FIG. 3, the contactor state signal from the battery management system 32 takes one of three different states, namely, “closed”, “open” and “warning”. The closed state indicates that the battery contactors are closed. The open state indicates that the contactors are open.

The warning state indicates that the battery contactors are currently closed but are about to open. The contactor state signal may change from “closed” to “warning” in two to three seconds (or some other value) before the battery contactors are opened.

In operation, the system control module 44 receives an accelerator pedal position signal from the vehicle's accelerator pedal, the battery contactor state signal (closed, warning or open) from the battery management system 32, and a signal from the electrical accessories 28 indicating their power demand. In addition, the system control module 44 receives a look-ahead signal from the electrical load predictor 52. Based on the received signals, the system control module 44 provides control signals for the engine control module 36, motor/generator inverter controller 38, traction motor inverter controller 40, electrical accessories 28 and brake resistor 54.

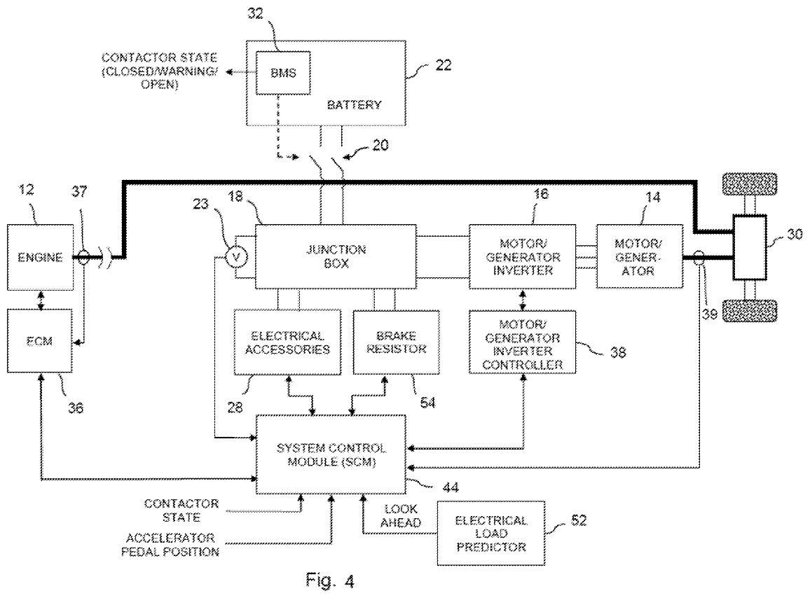

FIG. 4 shows parts of a hybrid powertrain system in another embodiment of the disclosure. Referring to FIG. 4, the system comprises engine 12, motor/generator 14, motor/generator inverter 16, junction box 18, contactors 20, battery 22, voltage sensor 23, electrical accessories 28, vehicle drivetrain 30, engine control module (ECM) 36, engine speed sensor 37, motor/generator inverter controller 38, motor/generator speed sensor 39, system control module 44, electrical load predictor 52 and brake resistor 54. The engine 12 and motor/generator 14 form a generator set. In contrast to the arrangement of FIG. 3, in FIG. 4 the engine 12 is mechanically coupled to the drivetrain 30. The engine control module 36 is configured to control the engine 12, for example by controlling the engine's intake air throttle (IAT) and/or other engine parameters. The engine speed sensor 37 senses the speed of the engine for use in the control process. The inverter controller 38 is used to control the inverter 16, and thus the motor/generator 14. The motor/generator speed sensor 39 senses the speed of the motor/generator for use in the control process. The inverter controller 38 comprises sensors such as voltage and/or current sensors which provide sensed values of voltage and/or current for use in the control process. The voltage sensor 23 senses the DC bus voltage and provides the sensed voltage to the system control module 44. The voltage sensor 23 may be part of the motor/generator inverter 16. The electrical load predictor 52 is used to produce a prediction of future electrical loads. The brake resistor 54 is used to dissipate excess energy when needed. The brake resistor 54 is connected to the DC bus and can be controlled with a switching device such as a transistor.

In the arrangement of FIG. 4, the contactor state signal from the battery management system 32 takes one of three different states, namely, “closed”, “open” and “warning”. The closed state indicates that the battery contactors are closed. The open state indicates that the contactors are open. The warning state indicates that the battery contactors are currently closed but are about to open. The contactor state signal may change from “closed” to “warning” in two to three seconds (or some other value) before the battery contactors are opened.

In operation, the system control module 44 receives an accelerator pedal position signal from the vehicle's accelerator pedal, the battery contactor state signal (closed, warning or open) from the battery management system 32, and a signal from the electrical accessories 28 indicating their power demand. In addition, the system control module 44 receives a look-ahead signal from the electrical load predictor 52. Based on the received signals, the system control module 44 provides control signals for the engine control module 36, motor/generator inverter controller 38, electrical accessories 28 and brake resistor 54.

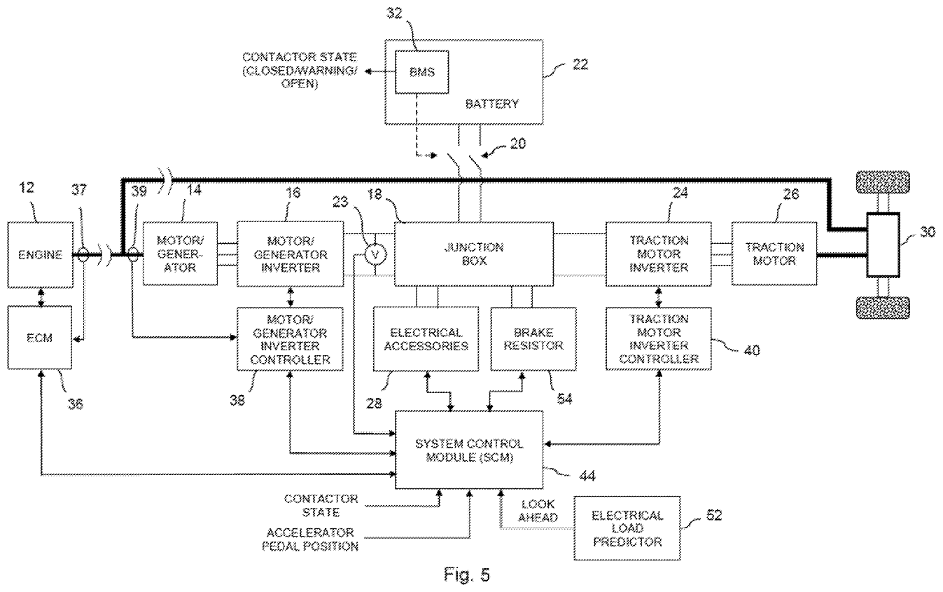

FIG. 5 shows parts of a hybrid powertrain system in another embodiment of the disclosure. Referring to FIG. 5, the system comprises engine 12, motor/generator 14, motor/generator inverter 16, junction box 18, contactors 20, battery 22, voltage sensor 23, traction motor inverter 24, traction motor 26, electrical accessories 28, vehicle drivetrain 30, engine control module (ECM) 36, engine speed sensor 37, motor/generator inverter controller 38, motor/generator speed sensor 39, traction motor inverter controller 40, system control module 44, electrical load predictor 52 and brake resistor 54. The engine 12 and motor/generator 14 form a generator set 15. In contrast to the arrangement of FIG. 3, in FIG. 5 the engine 12 is mechanically coupled to the drivetrain 30. The engine control module 36 is configured to control the engine 12, for example by controlling the engine's intake air throttle (IAT) and/or other engine parameters. The engine speed sensor 37 senses the speed of the engine for use in the control process. The inverter controller 38 is used to control the inverter 16, and thus the motor/generator 14. The motor/generator speed sensor 39 senses the speed of the motor/generator for use in the control process. The inverter controller 38 comprises sensors such as voltage and/or current sensors which provide sensed values of voltage and/or current for use in the control process. The inverter controller 40 is used to control the inverter 24, and thus the traction motor 26. The inverter controller 40 comprises sensors such as voltage and/or current sensors which provide sensed values of voltage and/or current for use in the control process. The voltage sensor 23 senses the DC bus voltage and provides the sensed voltage to the system control module 44. The voltage sensor 23 may be part of the motor/generator inverter 16 or part of the traction motor inverter 24. The electrical load predictor 52 is used to produce a prediction of future electrical loads. The brake resistor 54 is used to dissipate excess energy when needed, such as when the traction motor 26 is acting as a generator (for example, when the vehicle is decelerating or going downhill) and battery 22 and other components cannot take the regenerative energy/power anymore. The brake resistor 54 is connected to the DC bus and can be controlled with a switching device such as a transistor.

In the arrangement of FIG. 5, the contactor state signal from the battery management system 32 takes one of three different states. namely, “closed”, “open” and “warning”. The closed state indicates that the battery contactors are closed. The open state indicates that the contactors are open. The warning state indicates that the battery contactors are currently closed but are about to open. The contactor state signal may change from “closed” to “warning” in two to three seconds (or some other value) before the battery contactors are opened.

In operation, the system control module 44 receives an accelerator pedal position signal from the vehicle's accelerator pedal, the battery contactor state signal (closed, warning or open) from the battery management system 32, and a signal from the electrical accessories 28 indicating their power demand. In addition, the system control module 44 receives a look-ahead signal from the electrical load predictor 52. Based on the received signals, the system control module 44 provides control signals for the engine control module 36, motor/generator inverter controller 38, traction motor inverter controller 40, electrical accessories 28 and brake resistor 54.

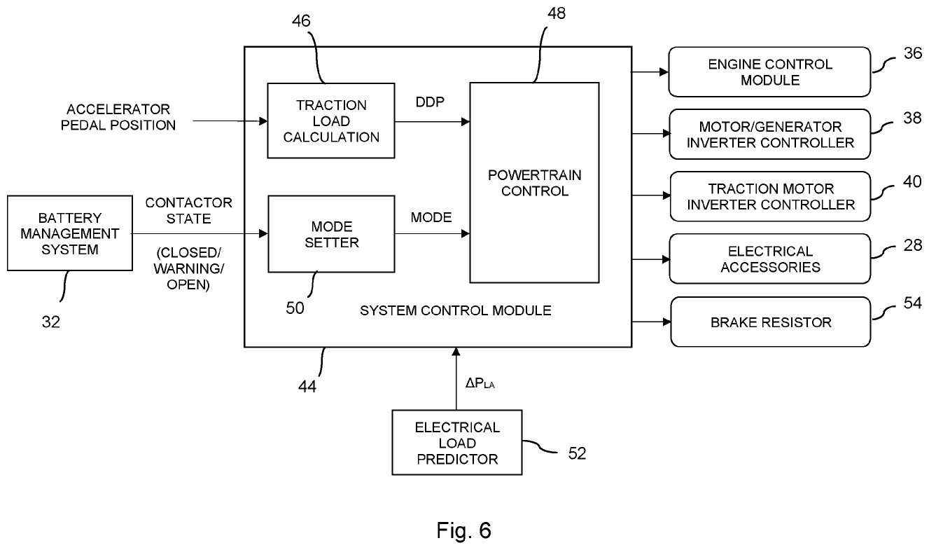

FIG. 6 shows in more detail parts of the control system of FIGS. 3, 4 and 5. Referring to FIG. 6, the control system comprises a system control module 44 which provides control signals for engine control module 36, inverter controller 38, inverter controller 40 (for architectures having a traction motor), electrical accessories 28 and brake resistor 54. In this embodiment, the system control module 44 includes a traction load calculation unit 46, mode setter 50, and a powertrain control unit 48. The system control module 44, and other parts of the control system, may be implemented as a processor executing the appropriate software, along with memory and other components. The system control module 44 and other control modules in FIG. 6, such as inverter controller 38, inverter controller 40, can be partially or fully integrated into one module, in an embodiment to reduce communication delays. As a consequence, the interfaces between the system control module and other controllers/modules are not necessarily the same between FIG. 2 and FIG. 6.

In operation, the mode setter 50 receives the contactor state signal (closed, warning or open) from the battery management system 32. The mode setter 50 uses the contactor state signal to decide whether to operate the control system in normal mode (contactors closed) or in a voltage control mode (contactors open). In normal mode operation, when the control system of FIG. 6 is used with the architecture of FIG. 3, the powertrain control unit 48 functions in a similar way to the power management unit 43 in FIG. 2. The mode setter 50 also decides whether the contactors are about to switch from a closed state to an open state based on the contactor state signal. If it is determined that the contactors are about to switch from a closed state to an open state, then the system control module 44 operates in a “prepare for battery disconnect” mode.

In the arrangement described above, the engine 12 is typically an internal combustion engine, such as a diesel engine or a spark-ignited (SI) engine. In this case, the ability of the generator set 15 to maintain the DC bus voltage may be limited by the torque response of the engine. For example, in the case of a spark-ignited engine, the torque response may be limited by the engine's air handling system. This may result in lags in the generator set meeting the demanded electrical load. This constraint may limit the capability of the generator set to maintain the DC bus voltage and the speed of the generator set if engine is in speed control mode or the torque the engine delivers if engine is in torque control mode while transitioning from a state in which the contactors are closed to a state in which the contactors are open. Furthermore, the bandwidth which is available from the generator set 15 to meet load transients while the contactors are open may be limited. In addition, particularly in the case of a spark-ignited engine, dead bands and low torque resolution zones in the engine torque map may make it difficult to maintain a stable DC bus voltage in all situations.

When the control system of FIG. 6 is used with the architecture of FIG. 3, during normal mode, the system control module 44 receives the accelerator pedal position signal and calculates control signals for the traction motor inverter controller 40 to meet the final driver demand power, in a similar way to the system described above. In this mode, the system controls the torque of the engine 12 and the speed of the motor/generator 14 (or vice versa) via the engine control module 36 and the motor/generator inverter controller 38, respectively, such a mode of operation being known in the art.

When the control system of FIG. 6 is used with the architecture of FIG. 4, during normal mode the system control module 44 receives the accelerator pedal position signal and calculates control signals for the engine controller 36 and the motor/generator inverter controller 38 to meet the final driver demand power.

When the control system of FIG. 6 is used with the architecture of FIG. 5, during normal mode, the system control module 44 receives the accelerator pedal position signal and calculates control signals for the engine controller 36, the motor/generator inverter controller 38, and the traction motor inverter controller 40 to meet the final driver demand power.

In “prepare for battery disconnect” mode, the system control module 44 switches the motor/generator 14 to voltage control mode. Also, in “prepare for battery disconnect” mode, the system control module 44 switches the engine 12 to speed control mode (if it is not already in speed control mode) for the architecture of FIG. 3, and to speed control mode (if it is needed and it is not already in speed control mode) for the architecture of FIG. 4 and in an embodiment of the architecture of FIG. 5. The needed condition for the architecture in FIG. 4 and the embodiment of the architecture of FIG. 5 is that the engine is operable in a speed control mode for example using a low speed governor or high speed governor, such arrangements being known in the art. In addition, various control levers, such as the engine 12, motor/generator 14, traction motor 26 (for architectures having a traction motor), electrical accessories 28, and brake resistor 54 are used to prepare the generator set 15 for the transition. The system control module 44 continues to operate the motor/generator 14 in voltage control mode and the engine 12 in speed control mode or torque control mode until the contactors open. Various parameters of the system are adjusted to ensure as far as possible that the engine is able to meet the required torque when the contactors are open. The “prepare for battery disconnect” mode will be explained in more detail below.

In voltage control mode, the system control module 44 calculates the electrical load, including driver demand power and accessories load demand, and provides corresponding speed or torque commands to the engine control module 36 and voltage commands to the motor/generator inverter controller 38 to meet the required load and maintain the DC bus voltage. The system control module also provides torque commands to the traction motor inverter controller 40 (for architectures having a traction motor), as well as control commands for the electrical accessories 28 and the brake resistor 54. In addition, the system control module 44 receives a look-ahead signal ΔP_{LA}, indicating a predicted change in the electrical load, from the electrical load predictor 52. This signal is used by the system control module 44 to prepare the generator set 15 for future loads by adjusting various system parameters in advance. This is achieved using the engine 12, motor/generator 14, traction motor 26 (for architectures having a traction motor), electrical accessories 28 and brake resistor 54 as control levers.

When operating in voltage control mode, the system control module 44 uses various control parameters in order to regulate the DC bus voltage while controlling the speed of the generator set if the engine is in speed control mode or the torque the engine delivers if the engine is in torque control mode to meet the electrical load demand with as high a bandwidth as possible. In this mode, the state variables are the DC bus voltage (at the output of the motor/generator inverter 16) and speed of the generator set. The control variables are nominal engine torque, amount of engine torque reserve, motor/generator torque, variation of traction motor torque from drive demand torque (for architectures having a traction motor), variation of accessories power from accessories power demand, and brake resistor power demand. The nominal engine torque is defined as the engine brake torque (the torque the engine delivers at the output shaft of the engine) if engine torque reserve is zero.

Using the principles of conservation of energy, the following equation can be written:

$$\frac{C}{2} \frac{{dV}_{DC}^{2}}{dt} + \frac{{V}_{DC}^{2}}{R} = - ( {T}_{MG 1} + Δ {T}_{MG 1} ) {ω}_{MG 1} + {T}_{MG 2} {ω}_{MG 2} - {P}_{ACC} - Δ {P}_{ACC} - {P}_{BR} \qquad ( Equation 1 )$$

where C is DC bus capacitance, R is DC bus resistance, V_{DC} is DC bus voltage, T_{MG1} is traction motor torque demand, ΔT_{MG1} is variation of traction motor torque from traction motor torque demand, ω_{MG1} is traction motor speed, ω_{MG2} is speed of generator set (the engine and motor/generator being mechanically coupled), T_{MG2} is motor/generator torque, P_{ACC} is the accessories power demand, ΔP_{ACC} is variation of accessories power from accessories power demand, and P_{BR} is brake resistor power.

Note that the first element on the right hand side of equation (1) only exists for the architectures having a traction motor.

The generator set mechanical dynamics can be described using the following equation:

$$J \frac{d {ω}_{MG 2}}{dt} + K {ω}_{MG} = α ( {T}_{ENG} + Δ {T}_{ENG} ) - {T}_{MG 2} - {T}_{whe \_ load} \qquad ( Equation 2 )$$

where T_{ENG} is nominal engine torque, ΔT_{ENG} is engine torque reserve (see below), α is a scaling factor which may be non-unity if a gear is provided between the engine and the motor/generator, and T_{wheel_load} is the load due to the wheels mechanically coupled to the generator set. For the series hybrid architecture in FIG. 3 and in an embodiment of the series-parallel hybrid architecture in FIG. 5, T_{wheel_load} does not exist in equation (2).

From equations (1) and (2) above, it can be seen that the values of nominal engine torque T_{ENG}, engine torque reserve ΔT_{ENG}, motor/generator torque T_{MG2}, variation of traction motor torque from drive demand torque ΔT_{MG1}; variation of accessories power from accessories power demand ΔP_{ACC}, and brake resistor power P_{BR} can be used as control variables to control the values of DC bus voltage V_{DC} and speed of generator set ω_{MG2}. Furthermore, it may be possible to adjust at least some of these parameters within certain limits without adversely affecting overall vehicle operation. Thus, in preferred embodiments, one or more of these parameters is used as a control lever to help maintain the DC bus voltage.

From equations (1) and (2), it also can be seen that the following behaviors hold true:
Higher engine torque T_{ENG}+ΔT_{ENG}→higher speed of generator set ω_{MG2} and vice versa;
Higher motor/generator torque T_{MG2}→lower speed of generator set W_{MG2} and higher DC bus voltage V_{DC} and vice versa;
Higher wheel load torque T_{wheel_load}→lower speed of generator set ω_{MG2} and vice versa;
Higher traction motor torque T_{MG1}→lower DC bus voltage V_{DC} and vice versa;
Higher accessories power demand P_{ACC}→lower DC bus voltage V_{DC} and vice versa;
Higher brake resistor power demand P_{BR}→lower DC bus voltage V_{DC} and vice versa.

These relationships are used by the voltage control system to control the values of DC bus voltage V_{DC} and speed of generator set ω_{MG2} when engine is in speed control mode or the torque the engine delivers when engine is in torque control mode. In particular, when the nominal engine torque T_{ENG} and motor/generator torque T_{MG2} are not capable of controlling the values of the DC bus voltage V_{DC} and speed of the generator set ω_{MG2} when the engine is in speed control mode or engine torque delivery capability error when the engine is in torque control mode, one or more of engine torque reserve ΔT_{ENG}, variation of traction motor torque from drive demand torque ΔT_{MG1}, variation of accessories power from accessories power demand ΔP_{ACC}, and brake resistor power P_{BR} are used as control variables to assist the generator set with regulation using equations (1) and (2) above.

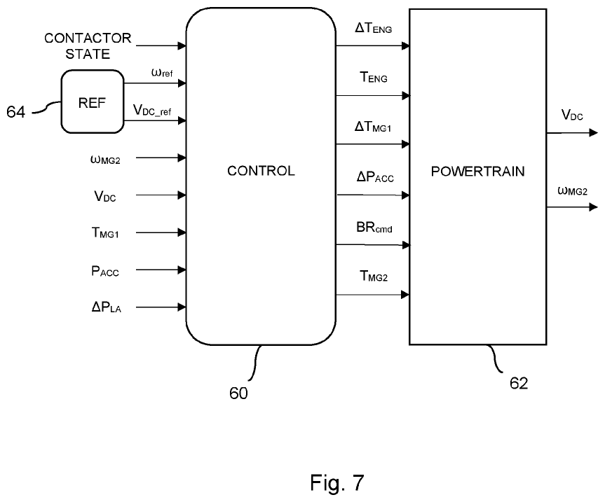

FIG. 7 is a block diagram of a voltage control system in an embodiment of the disclosure. Referring to FIG. 7, the system comprises control components 60, powertrain components 62 and speed and voltage referencing component 64. The control components 60 comprise the system control module 44, engine control module 36, part of motor/generator inverter controller 38, and part of traction motor inverter controller 40 of FIGS. 3, 4, 5, and 6. The powertrain components comprise the engine 12, the rest of motor/generator inverter controller 38, motor/generator inverter 16, motor/generator 14, the rest of traction motor inverter controller 40, traction motor inverter 24, traction motor 26, electrical accessories 28 and brake resistor 54 of FIGS. 3, 4, 5 and 6.

In operation, the control components 60 also receive the contactor status signal from the battery management system 32. Based on the status of this signal, the control components 60 decide whether the motor/generator should operate in normal mode or voltage control mode. When the motor/generator is in voltage control mode, the speed and voltage referencing component 64 generates a reference (desired) value of the DC bus voltage V_{DC_ref} and a reference (desired) value of speed of generator set ω_{ref}. The values of V_{DC_ref} and ω_{ref} are fed to the control components 60. The control components 60 also receive the value of speed of the generator set ω_{MG2} from the engine control module 36, the value of the DC bus voltage V_{DC} from the voltage sensor 23, a traction motor torque command signal T_{MG1} based on the accelerator pedal position (for architectures having a traction motor), and an accessories power command signal P_{ACC} based on the power demand of the electrical accessories. Based on the received inputs, the control components 60 produce an engine torque reserve signal ΔT_{ENG}, a nominal engine torque signal T_{ENG}, a traction torque adjustment signal ΔT_{MG1} (for architectures having a traction motor), electrical accessories power adjustment signal ΔP_{ACC}, brake resistor PWM (pulse width modulation) command signal BR_{cmd} and motor/generator torque signal T_{MG2}, all of which are fed to the powertrain components 62. The parameters of the powertrain components 62 are adjusted based on the received signals to regulate the values of the DC bus voltage V_{DC} and speed of the generator set ω_{MG2} using equations (1) and (2) above.

The control variables are:
Nominal engine torque T_{ENG};
engine torque reserve ΔT_{ENG};
motor/generator torque T_{MG2};
variation of traction motor torque from drive demand torque ΔT_{MG1} for architectures having a traction motor;
variation of accessories power from accessories power demand ΔP_{ACC};
brake resistor power P_{BR}.

The control objectives are:
V_{DC} tracks V_{DC_ref};
ω_{MG2} tracks ω_{ref} if engine is in speed control mode;
minimize ΔT_{MG1} (minimize change in driver's power request);
minimize ΔP_{ACC} (minimize change in accessories power demand);
minimize P_{BR} (minimize energy loss due to brake resistor).

Known disturbances in the system are:
traction motor torque T_{MG1} for architectures having a traction motor or wheel load torque T_{wheel_load} for architectures having the engine mechanically coupled to the wheels;
accessories power P_{ACC}.
Constraints in the system are:
T_{ENG_min}≤T_{ENG}≤T_{ENG_max} (engine is only able to operate in certain areas on the engine map);
P_{BR}≥0 (brake resistor only consumes energy and does not provide);
ΔP_{accmin}≤ΔP_{acc}≤ΔP_{accmax} (keep accessories power within allowed limits);
0<α_{MG1_min}≤ΔT_{MG1}/T_{MG1}≤α_{MG1_max} (maintain driver intention and driveability) for architectures having a traction motor;
ω_{MG2min}≤ω_{MG2}≤ω_{MG2max} (avoid engine stalling or overspeed);
V_{DCmin}≤V_{DC}≤V_{DCmax} (regulate DC bus voltage).

The main objective of the control is to control the DC bus voltage (i.e. V_{DC} tracks V_{DC_ref}) and control the speed of the generator set (ω_{MG2} tracks ω_{ref}) if the engine is in speed control mode or the torque the engine delivers if the engine is in torque control mode. This is because a stable DV bus voltage is needed to ensure proper operation of the vehicle powertrain and engine is not allowed to stall or be overspeed. Too low a voltage may affect the ability of the traction motor and/or accessories function correctly, while too high a voltage could be dangerous or could cause damage to the components on DC bus. Regulation of the speed of the generator set is primarily to ensure that the engine does not stall or is not overspeed as well as being in a good range for voltage control capability of the motor/generator. In addition, it is also desirable to operate in a specific area of the engine map to achieve fuel efficiency. Thus, the value of ω_{ref} is set such that the engine is able to operate efficiently in the desired area of the engine map.

An advantage of control system described above is that limitations in the torque response of the engine can be at least partially compensated for by adjusting other parameters of the powertrain system. In particular, when there are changes in load (for example, due to changes in driver power demand), parameters of the system such as engine torque reserve, variation of traction motor torque from drive demand torque (for architectures having a traction motor), variation of accessories power from accessories power demand, and brake resistor power can be used as control variables to respond quickly to the changes, allowing the engine time to respond to the new torque demand. This can help to maintain the DC bus voltage when the load changes. Furthermore, these parameters can be used for fine adjustment, allowing dead zones and low resolution zones of engine torque in the engine map to be avoided.

Still referring to FIG. 7, the control components 60 also receive a look-ahead signal ΔP_{LA} from the electrical load predictor 52. The look-ahead signal ΔP_{LA} is a signal indicating a predicted change in load at some point in the future. This signal is used by the control components 60 to prepare the generator set 15 for future loads by adjusting various system parameters in advance.

If ΔP_{LA} is above a certain threshold, indicating that the load is predicted to increase at some point in the future, then one or more of engine power reserve, accessories power consumption and brake resistor power consumption can be increased and/or the amount of regenerative braking decreased. Which of these measures is applied, and the amount by which they are applied, may depend on the amount of the predicted change in load. This can allow the system to respond rapidly to the increase in load when it occurs, by reducing or reversing some or all of the measures that were applied, allowing time for the generator set to respond to the increase in load.

On the other hand, if ΔP_{LA} is below a certain threshold, indicating that the load is predicted to decrease at some point in the future, then one or more of engine power reserve, accessories power consumption and brake resistor power consumption can be decreased and/or the amount of regenerative braking increased. Which of these measures is applied, and the amount by which they are applied, may depend on the amount of the predicted change in load. This can allow the system to respond rapidly to the decrease increase in load when it occurs, by reducing or reversing some or all of the measures that were applied, allowing time for the generator set to respond to the decrease in load.

The control can include both feedforward and feedback. The feedforward control is based on the model described by equation (1) and equation (2) and the inputs into the control components 60 except the DC bus voltage V_{DC} and the speed of the generator set ω_{MG2}. The feedback control is based on the feedback variables DC bus voltage V_{DC} and the speed of the generator set ω_{MG2}. It would also be possible to make the control system more complex, for example, by including a more detailed engine model and more engine control levers in the multivariable controller e.g. air-fuel-ratio, spark timing, variable valve timing/variable valve actuation, wastegate/variable-geometry turbocharger actuator, and instead of operating engine at the speed based on its optimal operation line as typically utilized in a normal hybrid powertrain, allowing it to run across the engine map. For a specific engine power, optimal operation line of an engine determines engine speed at which engine is at its highest brake thermal efficiency.

In the arrangement of FIGS. 3 to 7, the engine 12, motor/generator 14, traction motor 26 (for architectures having a traction motor), electrical accessories 28 and brake resistor 54 are all used as control levers to control the voltage of the DC bus. The bandwidth needed for the torque producing device (the engine 12) is determined based on the look-ahead electrical loads predictor 52, and by assessing the dynamics of the DC bus to determine if there is a mismatch in the bandwidth of the control compared to that of the load. The challenge of maintaining a stable DC bus voltage when the bandwidth of the torque producing device (engine) is less than the bandwidth of loads is addressed in the following ways:

The torque bandwidth of the engine is increased to be able respond to the dynamics of the loads. This can be achieved by using torque reserve. Torque reserve is a method of running the engine with lower brake thermal efficiency (BTE) to reserve torque. It provides the ability to gain fast torque when it is needed by changing BTE back to nominal.

Electrical loads from accessories (fans etc.) and/or the brake resistor are applied and removed to respond to dynamics.

Dynamics of the loads are decreased. This can be achieved using at least one of filtering, rate limiting, modification of the traction demand and certain accessories.

In addition, the challenge in maintaining stable DC bus voltage due to dead bands in the (SI) engine torque map can be addressed. In the negative torque area where the control resolution of the engine is not high, the rest of control levers with higher control resolutions are utilized in a multiple input multiple output scheme for controlling both speed and voltage.

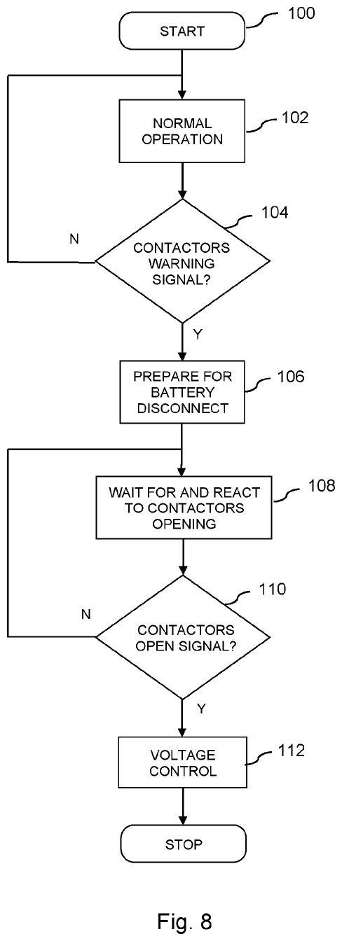

FIG. 8 is a flow chart showing overall operation of the system control module 44 in one embodiment. Referring to FIG. 8, processing starts in step 100. In step 102 the system is operated in normal operating mode. In this mode, when the battery 22 is connected to the junction box 18, there are different cases of the operation of the engine and the motor/generator depending on the hybrid architecture and the operating condition of the powertrain. In one case, the engine 12 is operated in torque control mode (i.e. its torque is controlled) and the motor/generator 14 is operated in speed control mode (i.e. its speed is controlled). In another case, the engine 12 operates in speed control mode and the motor/generator 14 operates in torque control mode. In another case, the engine 12 operates in torque control mode and the motor/generator 14 operates in power control mode. In another case, the engine 12 operates in torque control mode and the motor/generator 14 operates in torque control mode.

In step 104 it is determined whether or not the battery management system 32 is issuing a warning that the contactors 20 are about to open. If the contactors are not about to open, then processing returns to step 102 and the system continues to operate in normal operating mode. If on the other hand it is determined in step 104 that the contactors are about to open, then in step 106 the system is operated in “prepare for battery disconnect” mode. In this mode, various parameters of the system are adjusted to prepare for the transition. In particular, the motor/generator 14 is switched to voltage control mode and the engine 12 is switched to speed control mode or torque control mode depending on the hybrid architecture and the operating condition of the powertrain. In addition, various control levers, such as the engine 12, motor/generator 14, traction motor 26 (for architectures having a traction motor), electrical accessories 28, and brake resistor 54 are used to prepare the generator set 15 for the transition.

In step 108, the system enters a state of waiting for the contactors to open, and then reacting to the contactors opening. In this state, the voltage of the motor/generator 14 is controlled based on the voltage tracking error (the error between the reference voltage and the measured voltage at the output of the motor/generator inverter) and the speed of the engine is controlled based on the speed tracking error (the error between the reference speed and the measured speed) if the engine is in speed control mode or the torque of the engine is controlled to track the torque command (for example, based on accelerator pedal position in a parallel hybrid architecture). The system is then ready to react when the battery is disconnected.

When the contactors are opened, the load on the generator set changes due to the disconnection of the battery. This causes changes in the voltage tracking error and the speed tracking error (in the case of engine in speed control mode) or engine torque delivery capability error (in the case of engine in torque control mode). The system is able to react to the change based on the voltage tracking error and the speed tracking error (in the case of engine in speed control mode) or the engine torque delivery capability error (in the case of engine in torque control mode). In addition, other parameters, such as amount of engine torque reserve, electrical accessories power consumption, amount of brake resistance, and amount of allowed modification of traction motor torque (for architectures having a traction motor) may be adjusted to help compensate for the change.

In step 110 it is determined whether the contactors are opened. This may be done based on the contactor state signal from the battery management system 32. If the contactors have not opened, then processing returns to step 108. In practice, the contactors may still be opened during step 108 and the contactors open signal may indicate that the contactors are not opened yet. This can happen due to delay or lag in communication between the battery management system and the system control module 44. However, DC bus voltage and speed of generator set (if engine is in speed control mode) are still regulated in this scheme thanks to the reactive behavior of the controller in step 108. If the contactors have opened, then in step 112 the system is operated in voltage control mode, as will be explained below.

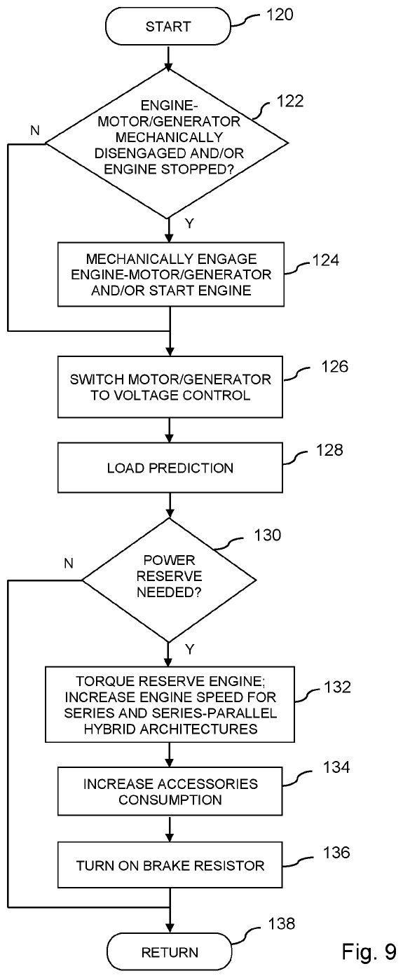

FIG. 9 is a flow chart showing steps taken when the system is in “prepare for battery disconnect” mode (step 106 in FIG. 8). Referring to FIG. 9, processing starts in step 120. In step 122 it is determined whether the engine and the motor/generator are mechanically disengaged and/or engine is switched off. The disengagement can take place if there is a clutch between the engine and the motor/generator and the clutch is disengaged. If the clutch is disengaged, then in step 124, the clutch is engaged. If the engine is switched off, then in step 124 the engine is started. Once the engine has engaged to the motor/generator and started, or if it was already running and engaged to the motor/generator, processing proceeds to step 126. In step 126 the engine 12 is switched from torque control mode to speed control mode (or is kept in speed control mode if it was already in speed control mode) in some embodiments, such as for the series hybrid architecture. In step 126 the engine 12 operates in speed control mode or torque control mode as in normal mode with the battery 22 connected depending on the operation of powertrain in some embodiments, such as for the parallel hybrid architecture. Also in step 126 the motor/generator 14 is switched from speed control mode (or torque control mode if it was in torque control mode, or power control mode if it was in power control mode) to voltage control mode. In this mode, the speed of the engine 12 (if the engine is in speed control mode) and the voltage at the output of the motor/generator inverter 16 are controlled in the manner described above.

In step 128, the electrical loads which will be placed on the system are predicted. This may be done based on the based on the accelerator pedal position and/or the look-ahead signal from the electrical load predictor 52, as well as any other indicators of future loads. In step 130 it is determined whether additional power will be needed to meet the predicted load when the battery is disconnected. If it is determined in step 130 that additional power will be needed, then one or more power reserve measures are performed. For example, in step 132, parameters of the engine are adjusted in order to reserve torque. In the case of a spark-ignited engine, this may be achieved by retarding the spark timing. The speed of the engine 12 may also be increased for series and series-parallel hybrid architectures, in order to provide further power reserve. In step 134, the energy consumption of the accessories is increased. In step 136, the brake resistor is turned on (or the power dissipated by the brake resistor is increased). It will be appreciated that, depending on the amount of power reserve that is required, not all of steps 134, 136 and 138 need be performed. Thus, in general, one or more of steps 134, 136 and 138 may be performed. The steps may also be performed in any order, or at the same time. Furthermore, the parameters of the torque reserve, engine speed increase (for series and series-parallel hybrid architectures), the energy consumption of the accessories and/or the power dissipated by brake resistor may be adjusted to optimize the capacity of the system to meet future load demand. In step 138 processing then returns to step 108 of FIG. 8.

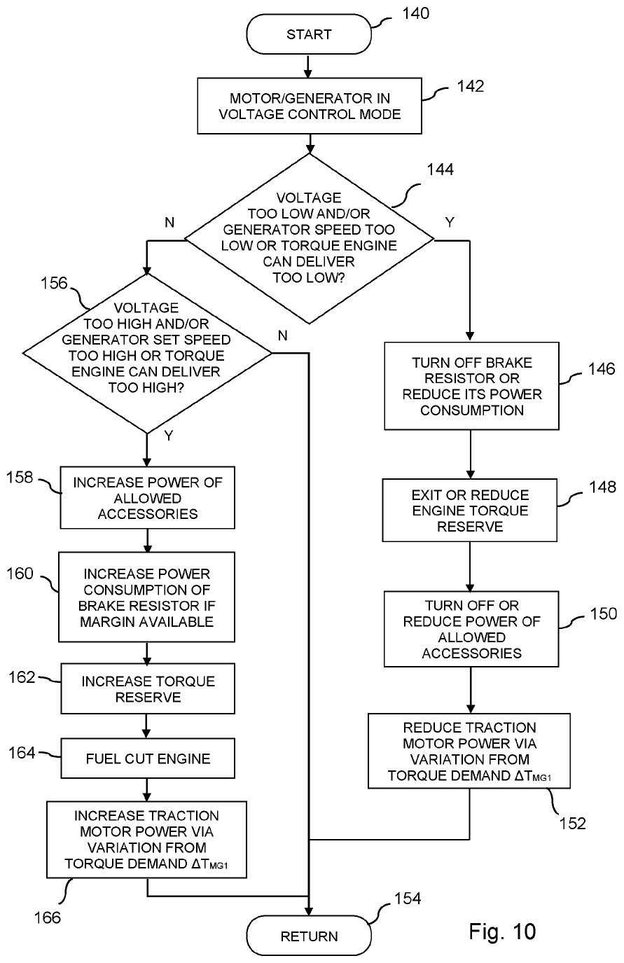

FIG. 10 is a flow chart showing steps taken when the contactors are first opened (during step 108 in FIG. 8). Referring to FIG. 10, processing starts in step 140. In step 142 the motor/generator 14 is operated in voltage control mode. In this mode, the speed of the engine 12 (if the engine is in speed control mode) or the torque the engine 12 delivers (if the engine is in torque control mode) and the voltage at the output of the motor/generator inverter 16 are controlled in the manner described above. In step 142, the nominal control levers such as nominal engine torque T_{ENG} (typically controlled via intake air throttle for stoichiometric spark-ignited engines and via fuel injection for diesel engines) and motor/generator torque T_{MG2} are used to control the DC bus voltage V_{DC} and the speed of the generator set ω_{MG2} (if the engine is in speed control mode) or the torque engine delivers (if the engine is in torque control mode). In step 144 it is determined whether the speed of the generator set is too low (if the engine is in speed control mode) or the torque the engine delivers is too low compared to the torque demand (if the engine is in torque control mode) and/or the DC bus voltage is too low to take further actions from the control actions in step 142. This may be determined, for example, by determining whether the difference between the target (reference) speed and the actual speed is greater than a threshold value (if the engine is in speed control mode) or whether the difference between the torque command and the torque the engine can deliver is greater than a threshold value (if the engine is in torque control mode) and/or the difference between the target (reference) voltage and the actual DC bus voltage is greater than a threshold value. If the speed of the generator set is too low (if the engine is in speed control mode) or the torque engine delivers is too low compared to the demand (if the engine is in torque control mode) and/or DC bus voltage is too low, then processing proceeds to step 146. In step 146 the control system turns off the brake resistor or reduces its power consumption. In step 148 the engine exits torque reserve mode or reduces torque reserve amount. In step 150 the control system switches off any accessories which can be switched off and/or reduces the power consumption of any accessories which can have their power consumption reduced. This step may comprise, for example, temporarily turning off or reducing the power consumption of a heater, a compressor and/or a fan. In step 152 the control system reduces the power of the traction motor by adjusting torque variation from torque demand ΔT_{MG1} (for architectures having a traction motor). Reducing power can be either decreasing the amount of power consumption or increasing the amount of regenerative braking within the allowed range. The allowed range is determined based on the availability of a regenerative braking margin, such as from the motor torque curve, and the acceptable vehicle driveability. In step 154, processing then returns to step 110 of FIG. 8.

Still referring to FIG. 10, if it is determined in step 144 that the speed of the generator set is not too low (if the engine is in speed control mode) or the torque the engine delivers is not too low compared to the torque demand (if the engine is in torque control mode) and the DC bus voltage is not too low, then in step 156 it is determined whether the speed of the generator set is too high (if the engine is in speed control mode) or the torque the engine delivers is too high compared to the torque command (if the engine is in torque control mode) and/or the DC bus voltage is too high. If the speed is not too high when the engine is in speed control mode (i.e. the speed is within its target range) or the torque the engine delivers is not too high compared to the torque command (if the engine is in torque control mode) and the DC bus voltage is not too high (i.e. the DC bus voltage is within its target range) then in step 154 processing returns to step 110 of FIG. 8. If on the other hand it is determined in step 156 that the speed is too high (if the engine is in speed control mode) or the torque the engine delivers is too high compared to the torque command (if the engine is in torque control mode) and/or the DC bus voltage is too high, then in step 158 the control system increases the power consumption of any accessories which can have their power consumption increased. However, if this is not sufficient, then further measures may be taken to bring the speed of the generator set and the DC bus voltage to within their target ranges. These measures may include, in step 160, modulating to increase brake resistor power consumption if there is a margin to do, in step 162, increasing the torque reserve of the engine if further torque reserve is available, in step 164, cutting the fuel to the engine, and in step 166 increasing traction motor power by adjusting torque variation from torque demand ΔT_{MG1}. Increasing power can be either decreasing the amount of regenerative braking or increasing the amount of power consumption within the allowed range. The allowed range is determined based on the availability of a power consumption margin, such as from motor torque curve, and the acceptable vehicle driveability. It will be appreciated that one or more of these steps may be taken, and the steps may be performed in any order or at the same time. In step 154 processing returns to step 110 of FIG. 8.

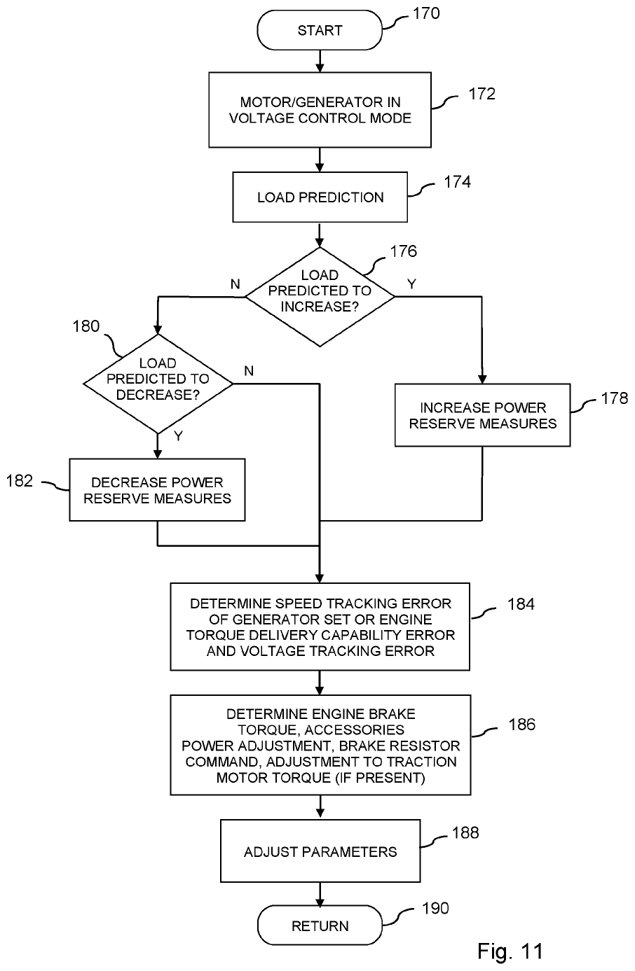

FIG. 11 is a flow chart showing steps taken when the system is in voltage control mode (step 112 of FIG. 8). Referring to FIG. 11, processing starts in step 170. In step 172 the motor/generator 14 is operated in voltage control mode. In this mode, the values of engine torque T_{ENG}, engine torque reserve ΔT_{ENG}, motor/generator torque T_{MG1} (for architectures having a traction motor), variation of traction motor torque from drive demand torque ΔT_{MG1} (for architectures having a traction motor), variation of accessories power from accessories power demand ΔP_{ACC}, and brake resistor power P_{BR} are used as control variables to control the values of DC bus voltage V_{DC} and speed of generator set ω_{MG2} (if the engine is in speed control mode) or torque the engine delivers (if the engine is in torque control mode) and meet the other control objectives, in the manner described above.

In step 174 the predicted electrical load is obtained from the electrical load predictor. In step 176 it is determined whether the electrical load is predicted to increase by more than a predetermined threshold. If the load is predicted to increase, then in step 178 measures are taken to reserve power, and thus increase the capacity of the system to respond to the increase in load. These measures may include one or more of: operating the engine in torque reserve mode; increasing engine speed (for series and series-parallel hybrid architectures); increasing the power consumption of accessories; turning on the brake resistor or increasing its power consumption. The amount by which these measures are applied may be varied in dependence on the amount by which the load is predicted to increase. Processing then proceeds to step 184.

If in step 176 it is determined that the electrical load is not predicted to increase, then in step 180 it is determined whether the load is predicted to decrease by more than a predetermined threshold. If the load is not predicted to decrease (i.e. the electrical load is predicted to remain within a predetermined range) then processing proceeds to step 184. If the load is predicted to decrease, then in step 182 power reserve measures are removed or decreased. This may include one of more of: turning off or decreasing engine torque reserve; decreasing engine speed closer or equal to the nominal value if it was previously increased for the purpose of power reserve; turning off or reducing power consumption of the brake resistor; reducing the power consumption of accessories. The amount by which these measures are applied may be varied in dependence on the amount by which the load is predicted to decrease. Processing then proceeds to step 184.

In step 184 the tracking error of the speed of the generator set (if the engine is in speed control mode) or the engine torque delivery capability error (if the engine is in torque control mode) and the voltage tracking error are determined. In step 186, based on the speed tracking error of the generator set (if the engine is in speed control mode) or the torque delivery capability error (if the engine is in torque control mode) and voltage tracking error, the nominal engine brake torque, the engine torque reserve, accessories power adjustment, brake resistor command and adjustment to the traction motor torque (for architectures having a traction motor) are calculated. Then in step 188 the various parameters of the system are adjusted, based on the determinations made in step 184, in the manner described above. This process continues for as long as the system is in voltage control mode. Steps 184 to 188 are described in in more detail in FIG. 10 to instantaneously control the speed of generator set (if the engine is in speed control mode) or the engine torque (if the engine is in torque control mode), regulate DC bus voltage and meet other requirements mentioned previously in this disclosure. When determining the action for power reserve, if there is a conflict between regulating the speed of the generator set (if the engine is in speed control mode) or the engine torque (if the engine is in torque control mode) and DC bus voltage at a moment in time and in the future, the decision is made with higher priority for controlling speed (if the engine is in speed control mode) or torque (if the engine is in torque control mode) and voltage at the moment in time.

### Torque Reserve

Torque reserve is a technique for reserving engine torque so that there is additional torque to draw upon should there be a sudden increase in load. In a spark-ignited engine, torque reserve can be achieved by retarding the spark timing.

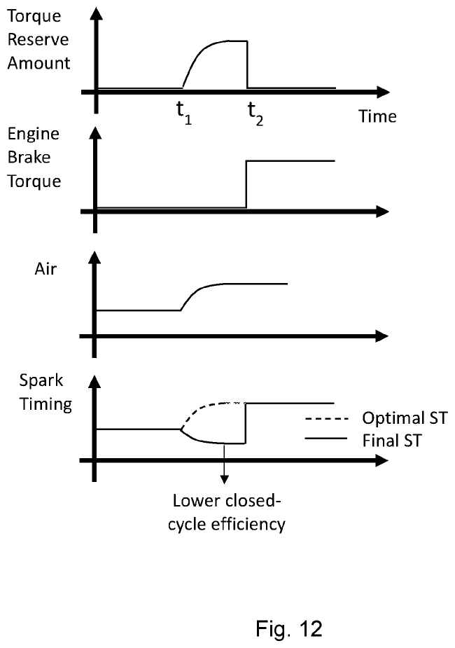

FIG. 12 illustrates the principle of torque reserve using spark timing. Referring to FIG. 12, at time t₁ the engine control module is aware that an additional load is imminent. The engine control module prepares to deliver torque at time t₂ by increasing air into the engine and retarding the spark time (ST) during the period t₁ to t₂. As a consequence, torque is maintained or reserved in this period. This period may be. for example, 2-3 seconds, and may correspond to the amount of warning given by the battery management system that the contactors are about to open.

At time t₂, the spark timing reverts to nominal/optimal within one engine cycle as the additional load appears. As an example, this may correspond to the moment at which the battery contactors are opened. This gives the engine the capability to deliver fast torque within one engine cycle, which would normally be difficult to achieve in a SI engine where torque depends on the response of air handling system. Using spark timing retard for torque reserve may heat up the aftertreatment system, which may help with emissions reduction.

Torque reserve can also be achieved in turbocharged engines using the wastegate. The wastegate is a valve that controls the flow of exhaust gases to the turbine wheel. During the torque reserve period, the wastegate is closed to spool up the turbine, thus increasing the turbocharger system's compressor outlet pressure. At the same time, the intake air throttle (IAT) is closed further to maintain the torque. When the additional torque is needed, the IAT is opened further to gain air/torque. Similar to wastegate, variable-geometry turbocharger (VGT) actuator can be used for an engine using VGT. Additional control levers of the engine such as variable valve actuation (VVA), variable valve timing (VVT) can also be used. If desired, spark timing, wastegate, and/or VVA/VVT can be used at the same time.

In the case that the torque load is reduced, in addition to using IAT as normal, spark timing can be retarded to reduce engine torque. This gives SI engines the capability to maintain speed of the generator set if the engine is in speed control mode or to meet torque demand faster if the engine is in torque control mode under more dynamic torque load.

The application of torque reserve is not limited to the moment that the battery contactors are opened, and it can also be used while the system is in voltage control mode to increase the bandwidth of generator set, especially when it is possible to predict future loads.

### Dead Zone and Low Control Resolution

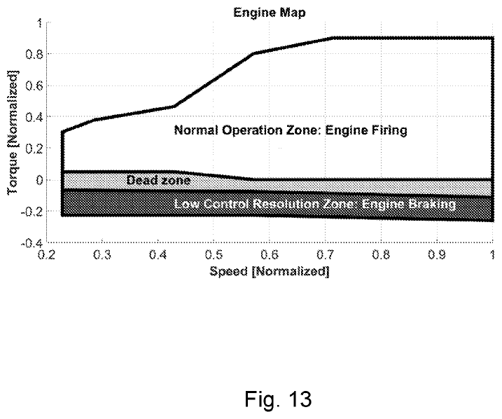

FIG. 13 shows the normalized engine map of a spark-ignited engine. Referring to FIG. 13, it can be seen that there is a dead zone area between the positive brake torque area and the motoring area. The dead zone is an area of the engine map where combustion is not sufficiently stable, and can be an intrinsic characteristic of spark-ignited engines. The dead-zone area may include zero brake torque at low speed.

Typically, torque control resolution is not high in the motoring and/or engine braking areas of the engine map. This may negatively impact control performance in voltage control mode. Therefore, when the contactors are open, the motor/generator is used to assist speed control if the engine is in speed control mode or torque control if the engine is in torque control mode and when it is needed (since control resolution with engine torque is not high). For example, in parallel hybrid architectures, the motor/generator torque cannot change engine delivery torque but the torque command to the engine with the same amount of wheel load can be changed. However, utilization of motor/generator in supporting speed control will impact voltage regulation performance. Therefore, the electrical accessories, brake resistor, and the traction motor (for architectures having a traction motor) are used to assist voltage regulation. Although there is no battery, regenerative braking of the traction motor can still be used. as the energy can be used for voltage regulation as well as for accessories energy consumption. Regenerative braking is beneficial, especially for heavy duty applications, to extend service brake life. Regenerative braking is the main reason why the negative operating region (motoring and engine braking) may be needed.

### Accessories Load Management

When the motor/generator 14 is in voltage control mode, the bandwidth of the powertrain system is limited. Therefore, using the accessories and the brake resistor as control levers to control the DC bus voltage is beneficial as it provides additional control input variables. Using the accessories and the brake resistor powers as control levers can therefore improve the bandwidth of the powertrain system.

Electrical accessories that can be used for this purpose include but are not limited to: fans; power steering if using motor and pump; cabin/aftertreatment heating; and other heating, ventilation, and air conditioning (HVAC) systems. These are accessories for which the power consumption can be varied without affecting the powertrain. For example, power steering (if using motor and pump) can increase the power drawn from powertrain (and turn it into heat) even when relatively little steering assistance is needed (such as at high vehicle speed) or a fan can be turned on. These can be used as fast control levers to regulate the DC bus voltage by turning on and off or increasing and decreasing power.

Turning on the brake resistor is similar to reserving torque with the engine. For voltage regulation, a brake resistor can be used to support fast bandwidth.

### Look-Ahead

The voltage control can be formulated as an optimal control problem. By utilizing look-ahead information, electrical loads, including driver demand power and some accessories loads can be predicted. Knowing electrical loads in the future, the engine, electrical accessories and the brake resistor can be prepared to provide faster control bandwidth using techniques such as engine torque reserve, turning on the brake resistor to prepare for the near future and turning off the brake resistor to respond to load demand. In other words, the optimal control problem when having look-ahead information can be formulated as a model predictive control or other optimal control methods knowing future information.

Various techniques can be used to predict future electrical load. For example, GPS data together with mapping information can be used to predict that the vehicle is about to encounter a hill. In this case, the predicted electrical load will increase if the vehicle is about to go up a hill, and decrease if the vehicle is about to go down a hill. As another example, in the case of a bus, if the vehicle is at a bus stop and the driver switches on the vehicle's indicators to indicate that the bus is about to pull out, this can be used to predict that the vehicle is about to accelerate, and thus that there will be an increase in electrical load. As a further example, the control system may know in advance before certain electrical accessories such as air conditioning are about to be switched on. Any other appropriate data, such as mapping data, weather data, traffic data, vehicle data, fleet data and historic information may be used in predicting the future electrical load. The predicted change in load ΔP_{LA} may be a continuous variable indicating the change in load which is predicted at a point in the future which is sufficiently far ahead to allow the engine to respond. For example, the predicted change in load may indicate the amount by which the load is expected to change from the present load at a point 2-3 seconds in the future. Alternatively, a range of predictions could be provided, and/or prediction over a finite time window in the future (the horizon) could be provided. The prediction vector over the horizon may be a vector versus time or a vector versus traveled distance.

### Battery Management System

Battery packs typically contain a battery management system (BMS) which is responsible for monitoring and management of the cells in the battery pack. During operation, the battery management system estimates an inner state of the battery, such a state of charge (SOC) and/or a state of health (SOH). The SOC provides information about the current amount of charge stored in the battery. The SOH is a figure of merit that indicates the level of battery degradation. The battery SOC and SOH may be monitored, for example, using the techniques disclosed in United States patent application publication number US 2021/0190867, the subject matter of which is incorporated herein by reference.

Monitoring the SOH in real time can allow battery fault diagnosis, which can help prevent hazardous situations from arising. If the battery management system determines that the SOH has deteriorated to an extent that continued operation of the battery may be hazardous, then it may instruct the contactors to disconnect the battery from the powertrain. This may also occur if other hazardous events such as overheating or overcurrent are detected. Before instructing the contactors to disconnect the battery, the battery management system may issue a warning signal indicating that disconnection is about to take place. This signal may be issued, for example, a few seconds before disconnection.

The techniques described above can be used to provide a limp-home mode capability for hybrid electric vehicles in the case of battery failure. As well as providing a limp-home mode, this functionality can help guarantee vehicle and driver safety because it allows continuous power to be provided for power steering, traction motor (for architectures having a traction motor), and critical accessories when battery contactors opened.

Although embodiments have been described above with reference to SI engines, the techniques described herein can also be used with diesel engines, or any other suitable types of engines. The techniques disclosed herein can be used with high voltage systems, or lower voltage systems (e.g. 48 V systems), or any other appropriate voltage. The techniques disclosed herein can be used with zero, one or more traction motors. The traction architecture can be no electric traction motor, single motor, dual motor, in-wheel motor, or any other types. The techniques disclosed herein can be used with one or more generator sets. The techniques disclosed herein can be used with one or more motors/generators. If desired, a separate starter motor could be used instead of using the motor/generator as a starter motor.

It will be appreciated that preferred features of the disclosure have been described above by way of example only, and that variations in detail may be made within the scope of the appended claims.

What is claimed is:

1. A control system for controlling a powertrain of a hybrid electric vehicle, the powertrain comprising an engine, a motor/generator, a battery and a DC bus, wherein the control system is configured to:
operate the motor/generator in a first mode when the battery is connected to the DC bus;
operate the motor/generator in a second mode when the battery is disconnected from the DC bus, wherein the second mode is a voltage control mode in which the motor/generator controls a voltage of the DC bus; and
adjust at least one parameter of the powertrain to assist the motor/generator in controlling the voltage of the DC bus in the second mode.

2. The control system according to claim 1, wherein the first mode is a mode in which at least one of a speed, torque, or power of the motor/generator is controlled.

3. The control system according to claim 1, wherein, in the second mode, the control system adjusts the at least one parameter of the powertrain to assist the engine in controlling a parameter of the engine.

4. The control system according to claim 3, wherein the parameter of the engine is engine speed if the engine is in a speed control mode or engine torque delivery if the engine is in a torque control mode.

5. The control system according to claim 1, wherein the control system is arranged to adjust the at least one parameter in response to a change in load on the DC bus.

6. The control system according to claim 1, wherein the parameter is at least one of: a power consumption of a power consuming component; and a power reserve of the engine.

7. The control system according to claim 6, wherein the power consuming component is at least one of: an electrical accessory; and a brake resistor.

8. The control system according to claim 1, wherein the control system is configured to use at least one of: nominal engine torque, engine torque reserve; motor/generator torque; variation of traction motor torque from drive demand torque; variation of accessories power from accessories power demand; and brake resistor power as a control variable to control the voltage of the DC bus.

9. The control system according to claim 1, wherein the control system is configured to receive a signal indicating that the battery is about to be disconnected or is disconnected from the DC bus and to operate the motor/generator in the voltage control mode when the battery is disconnected from the DC bus.

10. The control system according to claim 1, wherein the control system is configured to:
receive a signal indicating a predicted change in state of the DC bus; and
adjust the at least one parameter of the powertrain to assist the motor/generator in responding to the predicted change in state of the DC bus.

11. The control system according to claim 10, wherein the control system is configured to at least partially reverse the adjustment when the state of the DC bus changes.

12. The control system according to claim 10, wherein the signal indicating a predicted change in state is a signal indicating that the battery will be disconnected from the DC bus.

13. The control system according to claim 12, wherein the adjustment of the parameter comprises at least one of: turning on or increasing a power consumption of a power consuming component; and applying or increasing a power reserve of the engine.

14. The control system according to claim 10, wherein the signal indicating a predicted change in state is a signal indicating a predicted change in electrical load on the DC bus.

15. The control system according to claim 14, wherein the control system is configured such that, when the signal indicating a predicted change in state indicates that the load on the DC bus will increase, the control system performs at least one of: turning on or increasing a power consumption of a power consuming component; and applying or increasing a power reserve of the engine.

16. The control system according to claim 14, wherein the control system is configured such that, when the signal indicating a predicted change in state indicates that the load on the DC bus will decrease, the control system performs at least one of: turning off or decreasing a power consumption of a power consuming component; reducing or cancelling the power reserve measures; and removing or decreasing a power reserve of the engine.

17. The control system according to claim 1, wherein the control system is configured to adjust the at least one parameter of the powertrain to avoid operating the engine in a dead band and to assist the engine in low torque resolution zones in the engine's torque map.

18. A powertrain for a hybrid electric vehicle, the powertrain comprising:
an engine;
a motor/generator;
a DC bus;
a battery configured to supply power to the DC bus; and
a control system, wherein the control system is configured to:
operate the motor/generator in a first mode when the battery is connected to the DC bus;
operate the motor/generator in a second mode when the battery is disconnected from the DC bus, wherein the second mode is a voltage control mode in which the motor/generator controls a voltage of the DC bus; and
adjust at least one parameter of the powertrain system to assist the motor/generator in controlling the voltage of the DC bus in the second mode.

19. The powertrain according to claim 18, wherein:
the battery is removably connected to the DC bus;
the battery comprises a battery management system;
the battery management system is configured to output a signal indicating that the battery needs to be disconnected; and
the control system is configured to adjust the at least one parameter when a signal indicating that the battery will be disconnected is received.

20. A method of controlling a powertrain of a hybrid electric vehicle, the powertrain comprising an engine, a motor/generator, a DC bus and a battery for supplying power to the DC bus, the method comprising:
operating the motor/generator in a first mode when the battery is connected to the DC bus;
operating the motor/generator in a second mode when the battery is disconnected from the DC bus, wherein the second mode is a voltage control mode in which the motor/generator controls a voltage of the DC bus; and
adjusting at least one parameter of the powertrain to assist the motor/generator in controlling the voltage of the DC bus in the second mode.
